(19) United States
(12) Patent Application Publication
(10) Pub. No.: US 2013/0201937 A1
(43) Pub. Date: Aug. 8, 2013

(54) System and Method for Transmission Point (TP) Association and Beamforming Assignment in Heterogeneous Networks

(71) Applicant: FutureWei Technologies, Inc., Plano, TX (US)

(72) Inventors: Ruoyu Sun, Minneapolis, MN (US); Mingyi Hong, Minneapolis, MN (US); Mohammadhadi Baligh, Kanata (CA); Zhi-Quan Luo, Maple Grove, MN (US); Meisam Razaviyayn, Minneapolis, MN (US)

(73) Assignee: FUTUREWEI TECHNOLOGIES, INC., Plano, TX (US)

(21) Appl. No.: 13/757,303

(22) Filed: Feb. 1, 2013

Related U.S. Application Data
(60) Provisional application No. 61/596,047, filed on Feb. 7, 2012.

(51) Int. Cl. H04W 72/04

(52) U.S. Cl. CPC H04W 72/048
USPC 370/329

(57) ABSTRACT

Transmit point (TP) associations can be assigned to user equipments (UEs) by including a TP association variable within a sum-utility function traditionally used for computing beamforming weight vector assignments. Accordingly, maximization of the sum-utility function obtains both TP associations and beamforming weight vector assignments. Additionally, the sum-utility function may be computed in accordance with channel statistics, rather than channel state information (CSI), thereby reducing coordinated multi-point transmission (CoMP) related overhead.

This application claims the benefit of U.S. Provisional Application No. 61/596,047 filed on Feb. 7, 2012 and entitled “System and Method for Coordinated Transmission in a Heterogeneous Network,” which is incorporated herein by reference as if reproduced in its entirety.

### TECHNICAL FIELD

The present invention relates generally to systems and methods for transmission point (TP) association and beamforming assignment in heterogeneous networks.

### BACKGROUND

Modern day communication networks implement coordinated multipoint (CoMP) transmission techniques to increase data rates and improve wireless link performance through cooperative diversity. CoMP transmission is achieved by coordinating simultaneous transmissions from multiple transmit points (TPs) to a single user, and typically requires additional transmit-side processing to obtain TP associations and beamforming weight vector assignment. TP associations assign TPs to users in the network, while beamforming weight vector assignment governs the transmission parameters used by the various TPs (e.g., transmit power, etc.).

Generally, TP association and beamforming weight vector assignment are performed separately. For instance, TP association may be achieved via fixed TP association algorithm or arrange extension algorithm, while beamforming weight vector assignment may be achieved through maximization of a sum-utility function. More specifically, conventional TP association techniques (such as fixed TP association and range extension) provide localized solutions that do not account for global network conditions, and, as a result, tend to perform poorly during periods of high congestion. To with, fixed TP association is a greedy approach that assigns TPs based on their spatial proximity to the receiver, and therefore results in scheduling imbalance when some areas of the network are more crowded than others. Similarly, range extension is a quasi-greedy approach that assigns TPs based on their spatial proximity (like fixed TP association), but adds bias for macro base stations (BSs) such that pico BSs are reserved for extending the range of the macro cell. Accordingly, range extension TP association suffers similar performance limitations to fixed TP association. As such, a globalized approach to TP association is desired to improve wireless link performance in congested networks.

### SUMMARY OF THE INVENTION

Technical advantages are generally achieved, by embodiments of this disclosure which describe systems and methods for transmission point (TP) association and beamforming assignment in heterogeneous networks.

In accordance with an embodiment, a method of transmission point (TP) association is provided. In this example, the method includes obtaining channel information for a network comprising multiple transmit points, and maximizing a utility function in accordance with the channel information to obtain TP associations for user equipments (UEs) in the network. Each of the TP associations assigns transmit points to transmit data to a corresponding UE. An apparatus for performing this method is also provided.

In accordance with another embodiment, a method of beamforming weight vector assignment is provided. In this example, the method includes obtaining channel statistics for a network comprising multiple transmit points, and maximizing a sum-utility function in accordance with the channel statistics without using channel state information (CSI), thereby obtaining beamforming vector assignments for UEs in the network.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of a wireless network for communicating data;

FIG. 2 illustrates a flow chart of a method for obtaining TP associations and/or beamforming weight vector assignments; and

FIG. 3 illustrates a block diagram of an embodiment communications device.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Disclosed herein is a global approach for obtaining TP associations through maximization of a sum-utility function. More specifically, aspects of this disclosure include a TP association variable in a sum-utility function traditionally used for computing beamforming weight vector assignments. Accordingly, maximization of the sum-utility function obtains both TP associations and beamforming weight vector assignments. Additional aspects of this disclosure compute the sum-utility function in accordance with channel statistics (e.g., long-term, short-term, or otherwise), rather than channel state information (CSI), thereby reducing CoMP related overhead.

Beamforming achieves enhanced wireless link performance through spatial selectivity, and is effectuated by transmitting a signal over multiple antennas in accordance with a beamforming weight matrix (BF weight matrix) to produce a pattern of constructive and destructive interference in the wavefront. Beamforming weight vector assignment may typically include computing phase and amplitude shifts for a plurality of transmit paths through maximization of a sum-utility function. Conventionally, the sum-utility function may rely on channel state information (CSI) that is continuously fed back by the receivers. However, obtaining CSI may consume network resources (e.g., bandwidth, processing, etc.), as well as require complex baseband processing on the receiver-side. Accordingly, aspects of this disclosure reduce overhead by maximizing the sum-utility function in accordance with channel statistics, rather than CSI.

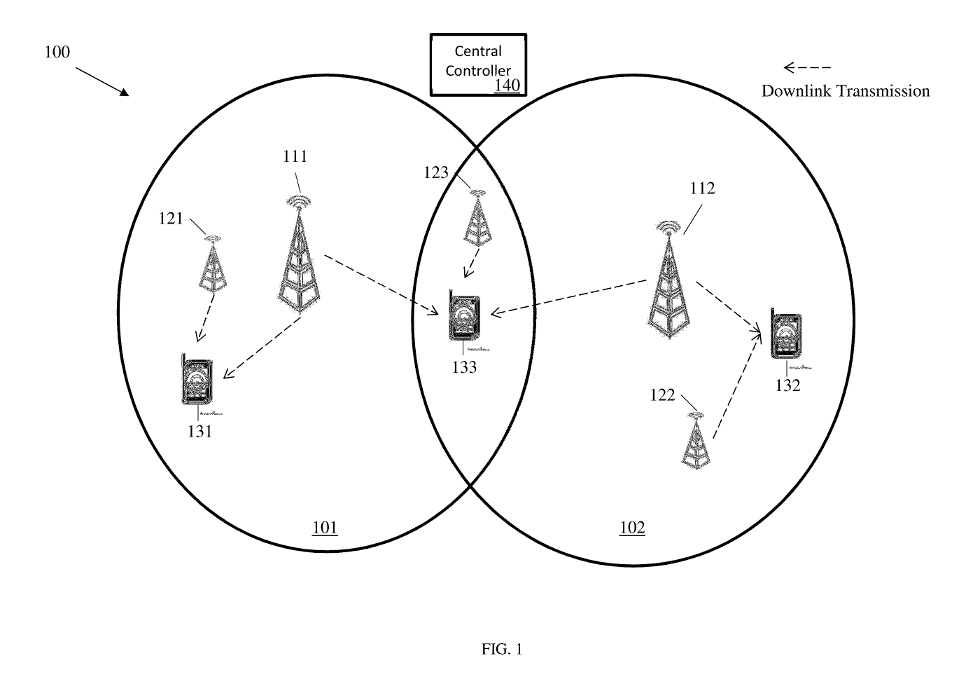

FIG. 1 illustrates a heterogeneous network (Het-Net) 100 for communicating data. The Het-Net 100 includes a plurality of cellular zones (cells) 101-102 in which macro base stations (BSs) 111-112 as well pico BSs 121-123 provide wireless access to user equipments (UEs) 131-133. The macro BSs 111-112 and pico BSs 121-123 may comprise any components capable of providing wireless access by, inter alia, performing downlink transmissions (dashed lines) to the UEs 131-133. For instance, the macro BSs 111-112 may include enhanced base stations (eNBs), while the pico BSs 121-123 may comprise femtocells. In some embodiments, some or all of the macro BSs 111-112 and/or pico BSs 121-123 may be interconnected via a backhaul network, which allows for them to exchange information (e.g., channel state information (CSI), channel statistics, scheduling information, etc.) in a fast and efficient manner. In some embodiments, the network 100 may comprise various other wireless devices, such as relays, etc. As discussed herein, the macro BSs 111-112 and the pico BSs 121-123 may be referred to as transmit points (TPs), and may perform coordinated multipoint (CoMP) transmissions to one or more of the UEs 131-133. The Het-Net 100 further comprises a central controller 140, which may be configured to perform TP associations and beamforming weight vector assignments in some embodiments. In other embodiments, the TP associations and beamforming weight vector assignments may be performed by the macro BSs 111-112 in a distributed fashion.

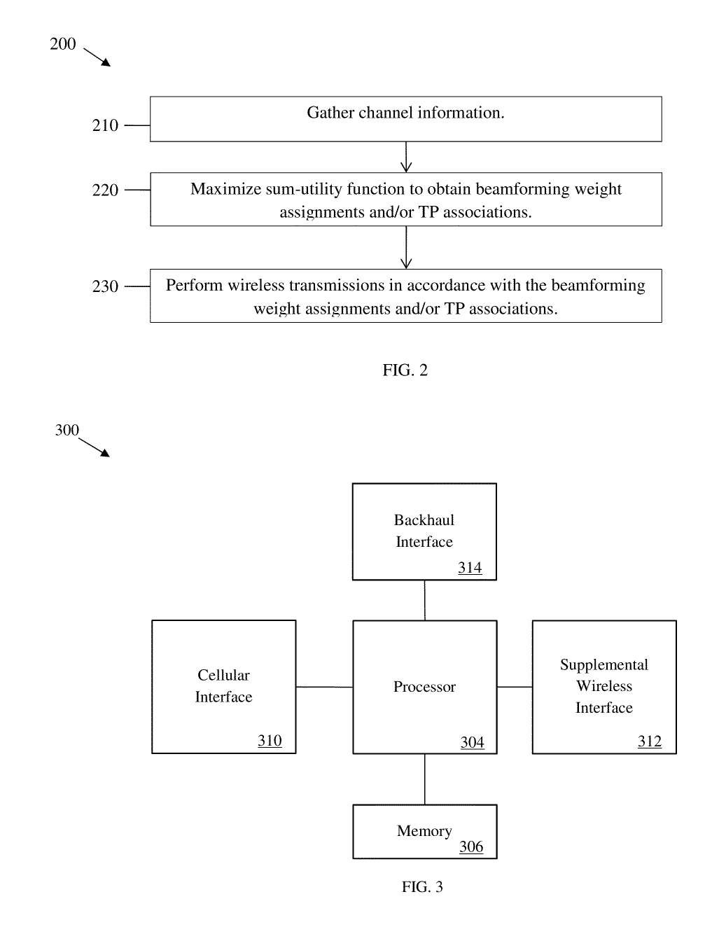

FIG. 2 illustrates a method 200 for obtaining beamforming assignments and/or transmit point (TP) associations in a wireless network, as might be performed by one or more base stations or centralized controller in a wireless network. The method 200 begins at step 210, where the base station(s) or centralized controller gathers channel information. In some embodiments, the channel information may include channel statistics and/or channel state information. Channel statistics may refer to information related to the random distribution of the channel coefficients, such as the mean and the variance. For instance, channel statistics may include the mean and variance of the channel coefficients, which may be determined by the distances between various transmit points and UEs, pathloss information, information that is pertinent to past channel conditions, and other channel information. In an embodiment, channel statistics may be obtained through transmission of a training channel and/or approximate testing channels. In an embodiment, the channel random distribution model may be a priori information. Conversely, channel state information (CSI) may include real-time characteristics of the air channel extending between the TPs and the receiver (e.g., fading, etc.), and may be obtained through implicit or explicit feedback. Next, the method 200 proceeds to step 220, where the base station(s) or centralized controller maximizes a sum-utility function in to obtain beamforming weight assignments and/or TP associations. Notably, the sum-utility function may be maximized in accordance with channel statistics, rather than channel state information, which may allow for reduced CoMP related overhead and/or receiver-side processing. Next, the method 200 proceeds to step 230, where base stations (macro, pico, or otherwise) perform wireless transmissions in accordance with the beamforming weight assignments and/or TP associations.

The following is brief explanation of the mathematical properties of the sum-utility function used to obtain long-term TP associations. Consider a HetNet with a number (K) of UEs and a number (N) of TPs (where K and N are integers greater than zero). In partial CoMP, each UE can be served by a set of TPs that share data via the backhaul links. A TP association may include a set of variables=(aₖₙ), where aₖₙε{0,1} denotes whether TP(n) is associated to UE(k). Consider a long-term TP association for L time slots (L is an integer). At time slot l, the channel is hₗ=(hₖₙ(l), where (hₖₙ(l) is a channel matrix between TP(n) and UE(k). At time slot l, the beamformers are denoted as v(l).

The long-term sum utility is as follows

$${f}_{1} = \frac{1}{L} {\sum }_{l = 1}^{L} {max}_{v ( l )} U ( {h}_{l} ) ,$$

where U(hₗ) is the short-term utility, a function defined over beamformers and parameterized by hₗ. In some embodiments, future channels may be unknown. Accordingly, the long-term sum utility ƒ₁ may be approximated by ƒ₂=Eₕ(maxᵥU). To maximize ƒ₂, it may be helpful to approximate the expectation in accordance with a sample average, e.g., a Sample Average Algorithm for stochastic programs. In embodiments, the sample average may be determined in accordance with a long-term sum utility of training channels as follows:

$${f}_{3} = \frac{1}{T} {\sum }_{t = 1}^{T} {max}_{v ( t )} U ( {h}_{t} ) .$$

In embodiments, there may be two constraints on the TP association variable a, namely: (i) aₖₙε{0,1} (which may be relaxed to aₖₙε[0,1]); and (ii) aₖ=(aₖ₁, . . . , aₖₙ, . . . , a_{kN}) (which may be sparse). In some embodiments, penalty terms (e.g., λₖ∥aₖ∥₁) may be added to the objective function in accordance with the second constraint. The sparse optimization function may be as follows:

$$( {P}_{2} ) {max}_{a , v ( 1 ) , … , v ( T )} \frac{1}{T} {\sum }_{t = 1}^{T} U ( {h}_{t} ) - {\sum }_{k = 1}^{K} {λ}_{k} {‖ {a}_{k} ‖}_{1} .$$

In some embodiments, a short-term utility function may be used for joint scheduling and beamforming weight vector assignment for a number (G) of resources (e.g., time-slots, frequency tones, etc.). The short-term objective function may be as follows: U=ƒ(R₁, . . . , Rₖ, . . . , R_{K}), where

$${R}_{k} = \frac{1}{G} {\sum }_{g = 1}^{G} {R}_{k}^{g}$$

is the sum rate for UE(k) in all groups. The utility function ƒ could be proportional fairness utility function (or other utility functions): ƒ(R₁, . . . , Rₖ, . . . , R_{K})=Σₖ log(Rₖ).

Hence, the sum-utility function may be expressed as:

$$( {P}_{2} ) {max}_{{a}_{kn} , {v}_{kn}^{g} ( t ) , {u}_{k}^{g} ( t ) , ∀ g , k , n , t} \frac{1}{T} {\sum }_{t = 1}^{T} f ( {R}_{1} ( t ) , … , {R}_{K} ( t ) ) - {\sum }_{k = 1}^{K} {λ}_{k} {‖ {a}_{k} ‖}_{1} .$$

This expression may be simplified subject to the following constraints: Σₖ₌₁^{K}aₖₙ∥vₖₙ^{g}(t)∥²≦Pₙ,∀g,k; 0≦aₖₙ≦1, ∀k, n;

$$0 \leq {‖ {v}_{kn}^{g} ( t ) ‖}^{2} \leq \frac{5}{K} {P}_{n} , ∀ k , g , t , n ,$$

where uₖ^{g}(t) is the receive beamforming parameter in group (g) and time-slot (t), vₖₙ^{g}(t) is the transmit beamforming parameter in group (g) and time-slot (t), and aₖₙ is the TP association variable. The utility function (ƒ) may be a proportional fairness function, or other utility functions.

It may be possible to solve for P₂-through application of a weighted minimum mean square error (WMMSE) transformation. As an example, the proportional fairness utility function may be given as follows: ƒ(R₁, . . . , Rₖ, . . . , R_{K})=εₖ log(Rₖ), the first term may be transformed in accordance with the following objective function

$${F}_{MSE} ( w , u , v , a ) = \frac{1}{T} {\sum }_{t = 1}^{T} {\sum }_{k = 1}^{K} ( - {\sum }_{g = 1}^{G} {w}_{k}^{g} ( t ) {e}_{k}^{g} ( t ) + {f}_{aux} ( {w}_{k}^{1} ( t ) , φ ( {w}_{k}^{1} ( t ) ) , … , {w}_{k}^{G} ( t ) , φ ( {w}_{k}^{G} ( t ) ) ) ,$$

where ƒₐᵤₓ and φ are selected such that stationary point of

$${max}_{w} {F}_{MSE} ( w , u , v , a ) is {w}_{k}^{g} ( t ) = \frac{1}{{e}_{k}^{g} ( t ) [ {R}_{k}^{1} ( t ) + … + {R}_{k}^{G} ( t ) ]} .$$

In some embodiments, the objective function of (P₂) may be replaced by F_{MSE}(w, u, v, a)+Σₖ₌₁^{K}λₖ∥aₖ∥₁. This function may be minimized by alternate minimization, which may include the following steps: (i) Update w in accordance with

$${w}_{k}^{g} ( t ) = \frac{1}{{e}_{k}^{g} ( t ) [ {R}_{k}^{1} ( t ) + … + {R}_{k}^{G} ( t )} ;$$

(ii) update u in accordance with the MMSE receiver; (iii) update v by solving a quadratically constrained quadratic program (QCQP). The QCQP may be solved by gradient projection algorithm (where projecting is approximated by shrinking). It may be beneficial to use BarzilaiBorwein (BB) step size (or other stepsize rules such as diminishing stepsize, constant stepsize, etc.); (iv) update a by solving a QCQP via an approximate gradient projection method, using BB stepsize rule or other stepsize rules.

FIG. 3 illustrates a block diagram of an embodiment of a communications device 300, which may be equivalent to a TP or centralized controller discussed above. The communications device 300 may include a processor 304, a memory 306, a cellular interface 310, a supplemental wireless interface 312, and a backhaul interface 314, which may (or may not) be arranged as shown in FIG. 3. The processor 304 may be any component capable of performing computations and/or other processing related tasks, and the memory 306 may be any component capable of storing programming and/or instructions for the processor 304. The cellular interface 310 may be any component or collection of components that allows the communications device 300 to communicate using a cellular signal, and may be used to receive and/or transmit information over a cellular connection of a cellular network. The supplemental wireless interface 312 may be any component or collection of components that allows the communications device 300 to communicate via a non-cellular wireless protocol, such as a Wi-Fi or Bluetooth protocol, or a control protocol. The device 300 may use the cellular interface 310 and/or the supplemental wireless interface 312 to communicate with any wirelessly enabled component, e.g., UE, mobile device, base stations, etc. The backhaul interface 314 may be any component or collection of components that allows the communications device 300 to communicate via a backhaul network, and may be used to exchange CoMP related information (e.g., channel information, TP associations, etc.).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed:

1. A method of transmission point (TP) association, the method comprising:
obtaining, by a device, channel information for a network comprising a plurality of transmit points; and
maximizing, by the device, a utility function in accordance with the channel information to obtain TP associations for a plurality of user equipments (UEs) in the network, wherein each of the TP associations assign one or more of the plurality of transmit points to transmit data to a corresponding one of the plurality of UEs.

2. The method of claim 1, wherein the utility function is a sum-utility function that includes a TP association variable.

3. The method of claim 2, wherein the channel information includes channel statistics.

4. The method of claim 3, the channel information excludes channel state information (CSI).

5. The method of claim 2, wherein maximizing the sum-utility function comprises: maximizing a long-term utility function in accordance with the following equation:
$$( {P}_{2} ) {max}_{a , v ( 1 ) , … , v ( T )} \frac{1}{T} {\sum }_{t = 1}^{T} U ( {h}_{t} ) - {\sum }_{k = 1}^{K} {λ}_{k} {‖ {a}_{k} ‖}_{1} .$$

6. The method of claim 5, wherein the TP associations are long term TP associations that assign transmit points over multiple timeslots.

7. The method of claim 2, wherein maximizing the sum-utility function comprises: maximizing a utility function in accordance with the following equation:
$$( {P}_{2} ) {max}_{{a}_{kn} , {v}_{kn}^{g} ( t ) , {u}_{k}^{g} ( t ) , ∀ g , k , n , t} \frac{1}{T} {\sum }_{t = 1}^{T} f ( {R}_{1} ( t ) , … , {R}_{K} ( t ) ) - {\sum }_{k = 1}^{K} {λ}_{k} {‖ {a}_{k} ‖}_{1} .$$

8. The method of claim 5, wherein the beamforming weights assignments are short term beamforming weights assignments allocated for a single time slot.

9. The method of claim 2 further comprising:
performing, by the device, wireless transmissions to one or more of the plurality of UEs in accordance with the TP associations, wherein the device comprises one of the plurality of transmit points.

10. The method of claim 2 further comprising:
communicating, by the device, the TP associations to the plurality of transmit points, wherein the device comprises a centralized controller in the network.

11. An apparatus comprising:
a processor; and
a computer readable storage medium storing programming for execution by the processor, the programming including instructions to:
obtain channel information for a network comprising a plurality of transmit points; and
maximize a utility function in accordance with the channel information to obtain transmit point (TP) associations for a plurality of user equipments (UEs) in the network, wherein each of the TP associations assigns one or more of the plurality of transmit points to transmit data to a corresponding one of the plurality of UEs.

12. The apparatus of claim 11, wherein the utility function is a sum-utility function that includes a TP association variable.

13. The apparatus of claim 12, wherein the channel information includes channel statistics.

14. The apparatus of claim 13, the channel information excludes channel state information (CSI).

15. A method of beamforming weight vector assignment, the method comprising:
obtaining channel statistics for a network comprising a plurality of transmit points; and maximizing a sum-utility function in accordance with the channel statistics without using channel state information (CSI), thereby obtaining beamforming vector assignments for one or more user equipments (UEs) in the network.

16. The method of claim 15, wherein the channel statistics comprise distances between at least one of the plurality of transmit points and one or more user equipments (UEs) in the network.

17. The method of claim 15, wherein maximizing the sum-utility function comprises: maximizing a long-term utility function in accordance with the following equation:
$$( {P}_{2} ) {max}_{a , v ( 1 ) , … , v ( T )} \frac{1}{T} {\sum }_{t = 1}^{T} U ( {h}_{t} ) - {\sum }_{k = 1}^{K} {λ}_{k} {‖ {a}_{k} ‖}_{1} .$$

18. The method of claim 15, wherein maximizing the sum-utility function comprises: maximizing the sum-utility function in accordance with the following equation:
$$( {P}_{2} ) {max}_{{a}_{kn} , {v}_{kn}^{g} ( t ) , {u}_{k}^{g} ( t ) , ∀ g , k , n , t} \frac{1}{T} {\sum }_{t = 1}^{T} f ( {R}_{1} ( t ) , … , {R}_{K} ( t ) ) - {\sum }_{k = 1}^{K} {λ}_{k} {‖ {a}_{k} ‖}_{1} .$$

19. An apparatus comprising:
a processor; and
a computer readable storage medium storing programming for execution by the processor, the programming including instructions to:
obtain channel statistics for a network comprising a plurality of transmit points; and
maximize a sum-utility function in accordance with the channel statistics without using channel state information (CSI), thereby obtaining beamforming vector assignments for one or more user equipments (UEs) in the network.

20. The method of claim 15, wherein the channel statistics comprise distances between at least one of the plurality of transmit points and one or more user equipments (UEs) in the network.
